(19) United States
(12) Patent Application Publication
(10) Pub. No.: US 2005/0224157 A1
(43) Pub. Date: Oct. 13, 2005

(54) Method for mounting a removable decorative device on a wall

(76) Inventor: Dana J. Orlich, Tarpon Springs, FL (US)

Correspondence Address: LARSON AND LARSON, 11199 69TH STREET NORTH, LARGO, FL, 33773, US

(21) Appl. No.: 10/813,420

(22) Filed: Mar. 30, 2004

(51) Int. Cl. B32B 31/00

(52) U.S. Cl. 156/93

(57) ABSTRACT

A desired fabric pattern is glued to a top surface of a polymeric crease resistant backing material and a threaded outline of the pattern is stitched to the backing material. The design pattern is cut away from the backing material not covered by the threaded outline and double sided sticky tape is applied to a back surface of the backing material so that the design pattern can be removably applied to a wall surface.

### BACKGROUND OF THE INVENTION

This invention relates to decorative devices mounted on a wall. More specifically, it refers to a method for making a sewn decorative pattern and removably mounting such pattern on a wall.

Picture kits such as described in U.S. Pat. No. 3,236,368 and various display boards as shown in U.S. Pat. Nos. 3,280,972 and 3,440,750 are well known and are useful for their intended purpose. However, none of these picture kits or display boards provide for mounting a given display pattern of defined edges on a wall surface from which the display pattern can be readily removed. A way to mount decorative displays on a child's room wall that can provide for movement to different locations without adult help is needed.

### SUMMARY OF THE INVENTION

The subject invention provides a solution to the problem stated by applying a desired decorative pattern to a front surface of a polymeric crease resistant backing material and then stitching the decorative pattern to the backing material. After extraneous backing material is cut away, the decorative pattern stitched to the backing material is completed. Applying doubled sided tape to the back surface of the polymeric backing material allows a child to stick the decorative pattern to a wall surface and easily remove it for transfer to another location without any residue surface impairment or product damage.

### BRIEF DESCRIPTION OF THE DRAWINGS

The invention is best understood by those having ordinary skill in the art by reference to the following detailed description when considered with the accompanying drawings in which:

FIG. 1 is a perspective view of a polymeric backing material containing glue on a top surface.

FIG. 2 is an exploded view of a decorative design being glued to the polymeric backing material.

FIG. 3 is a perspective view of the decorative design glued to the polymeric backing material.

FIG. 4 is a perspective view of the decorative design stitched in place over the polymeric backing material.

FIG. 5 is a perspective view of the decorative design including stitching cut away from extraneous portions of the polymeric backing material.

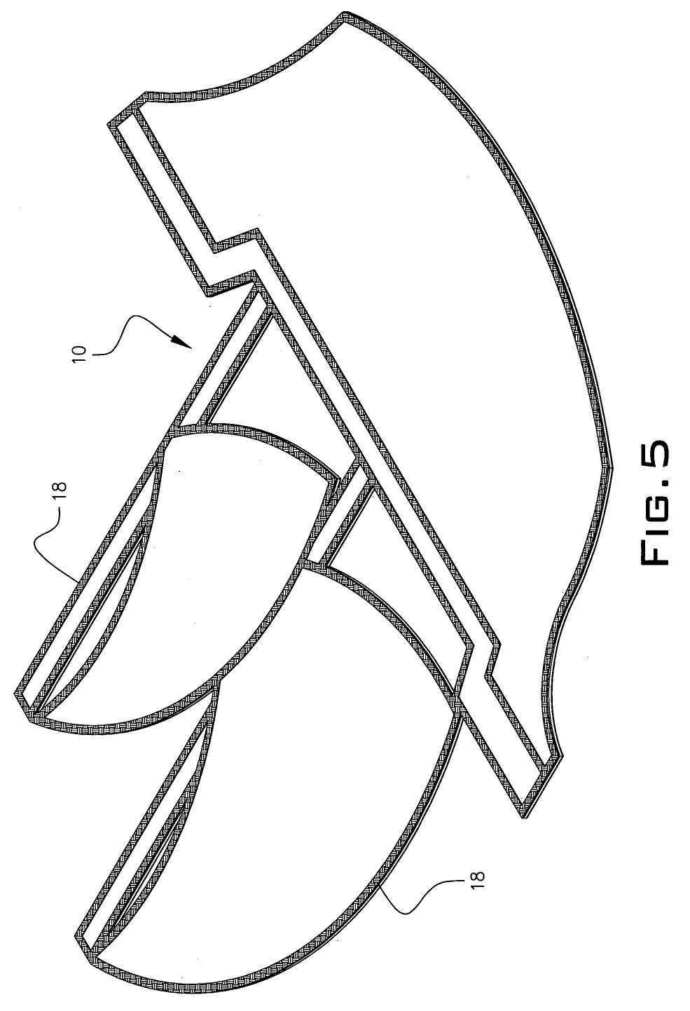

FIG. 6 is a perspective view of a back surface of the polymeric backing material containing double sided sticky tape.

FIG. 7 is a perspective view of back surface of the polymeric backing material with the double sided tape being removed for replacement.

FIG. 8 is a perspective top surface view of the decorative design showing the placement of a voice or music chip.

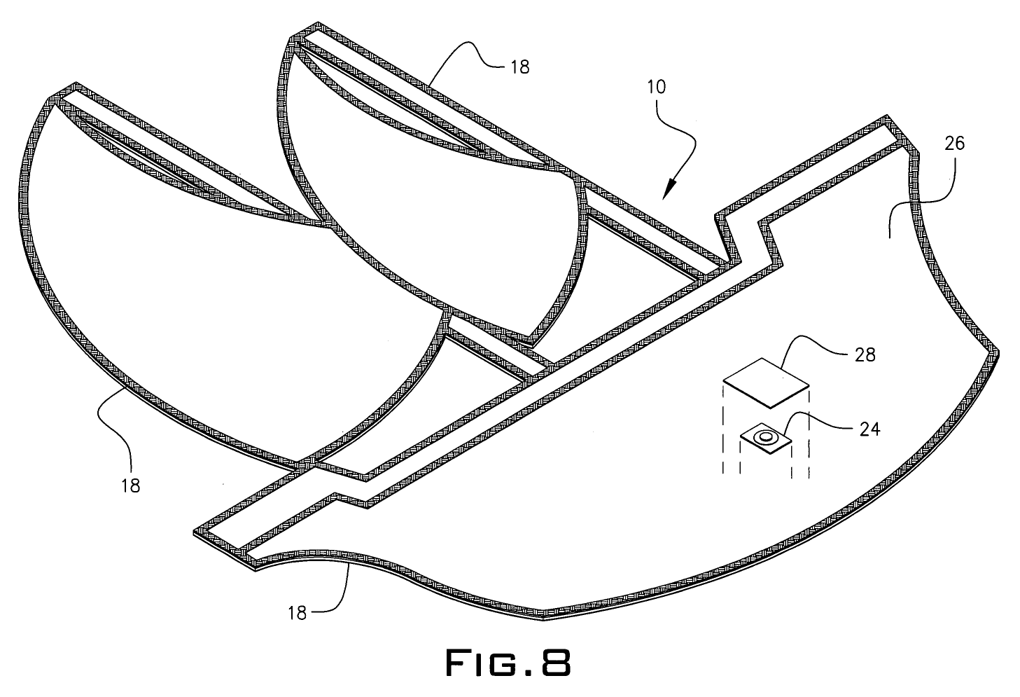

FIG. 9 is a perspective view according to FIG. 8 with the chip sewn in place.

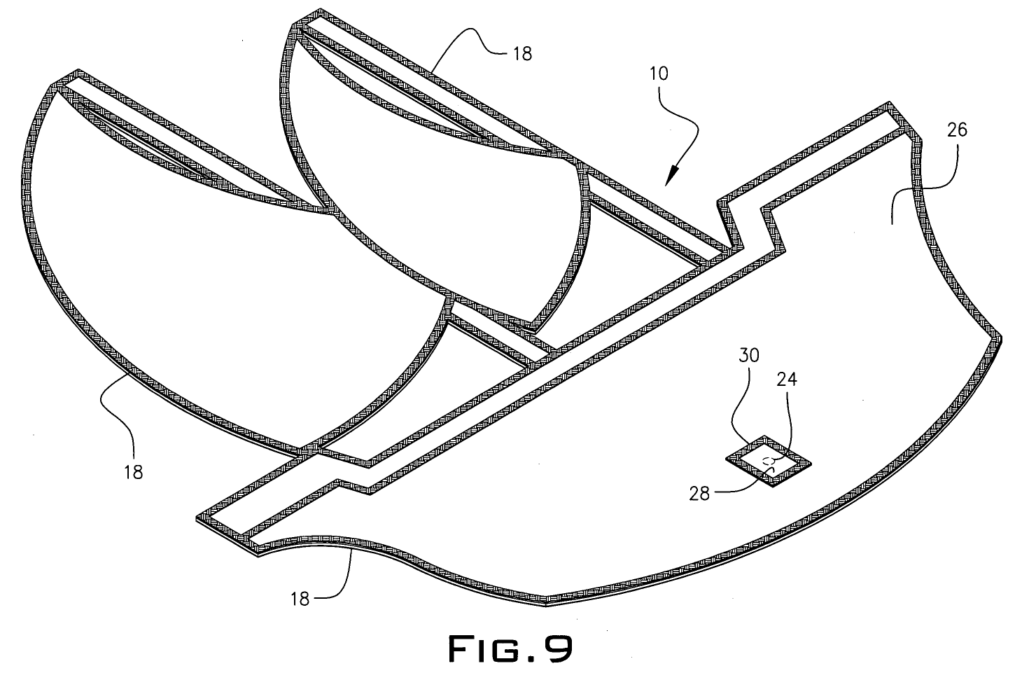

### DETAILED DESCRIPTION OF THE BEST MODE

Throughout the following detailed description, the same reference numerals refer to the same elements in all figures.

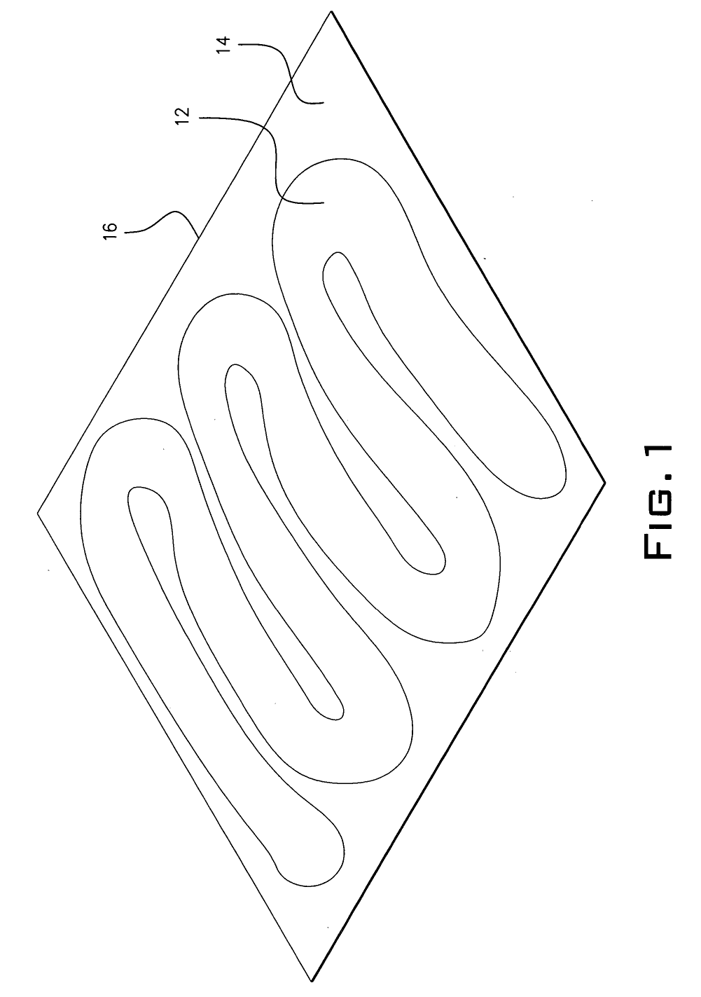

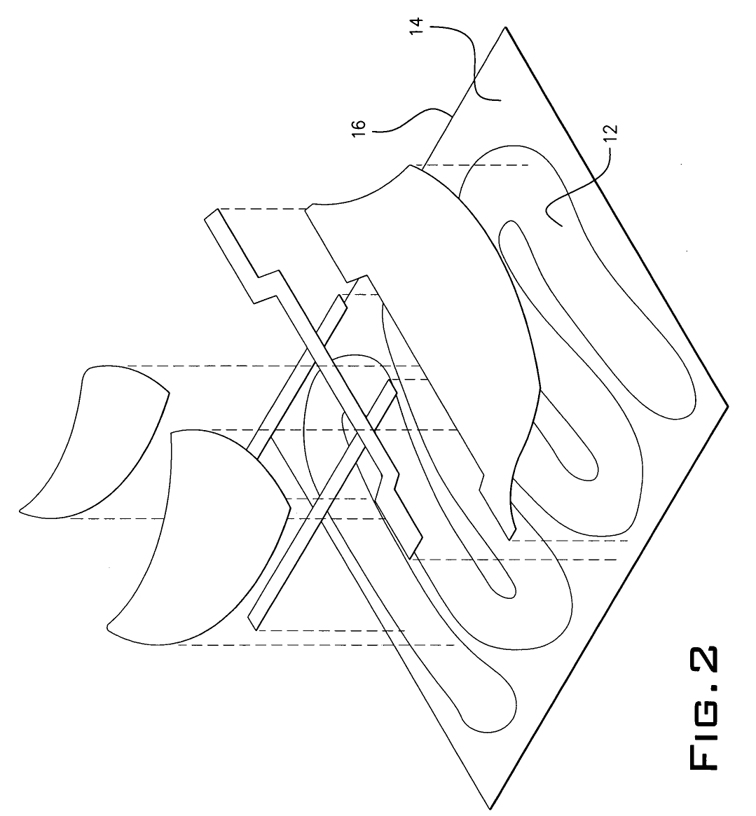

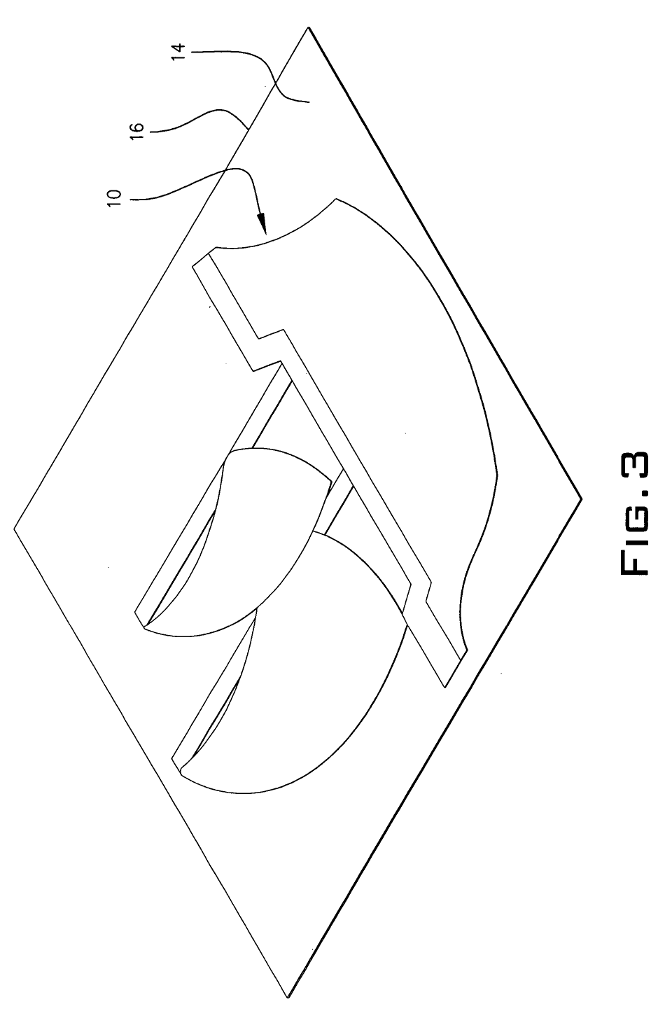

Referring to FIGS. 1-3, a decorative pattern 10 is first applied with glue 12 to a top surface 14 of a crease resistant polymeric backing material 16 such as polypropylene. Various components of the decorative design pattern, as shown in FIG. 2, can be joined together on backing material 16 with glue 12. The components are a fabric material such as cotton or combinations of cotton with polymeric materials.

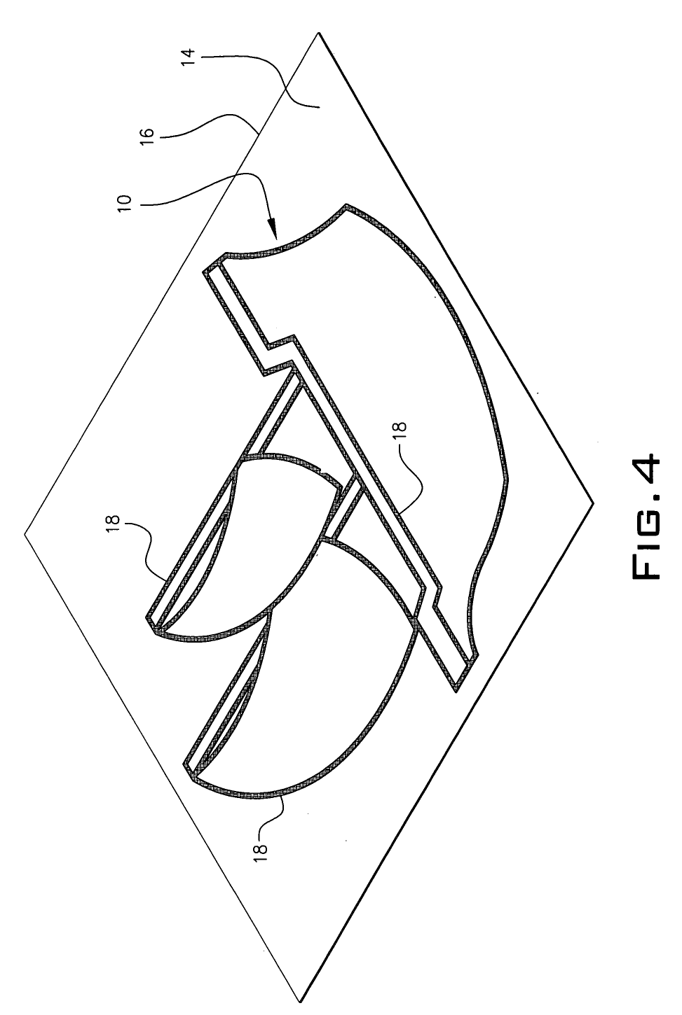

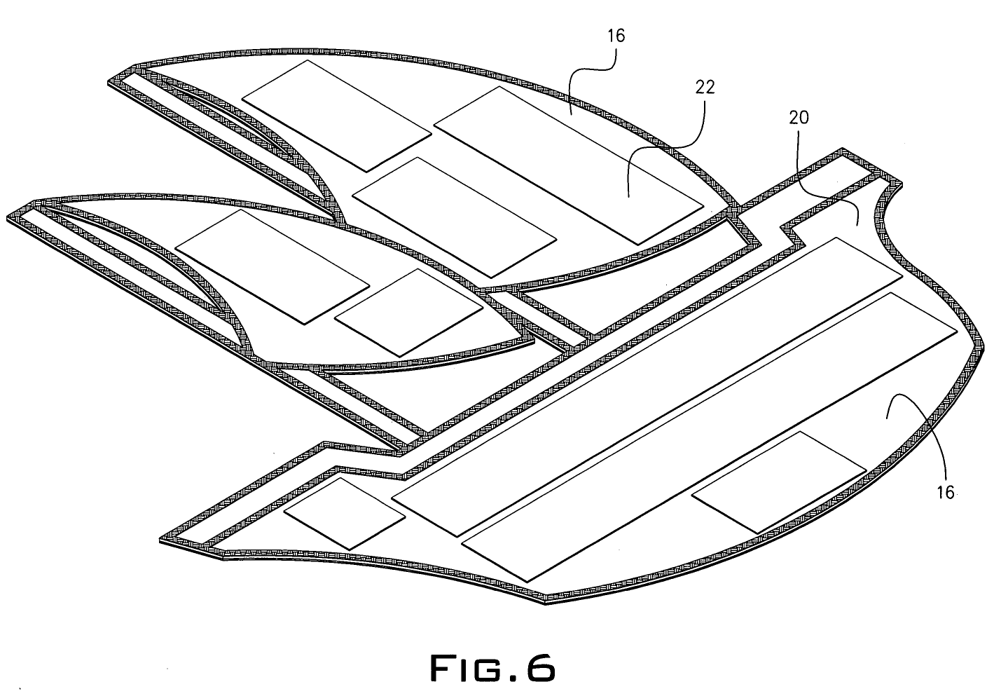

After the decorative pattern 10 is satisfactorily glued to backing material 16, the outline of the decorative pattern 10, as shown in FIG. 4, is stitched with thread 18. Carefully, the outline of the decorative pattern 10 is cut out of the backing material 16 so that extraneous backing material is discarded and only the back surface of the decorative pattern 10 contains backing material 16. The back surface 20 of the backing material 16 is shown in FIG. 6.

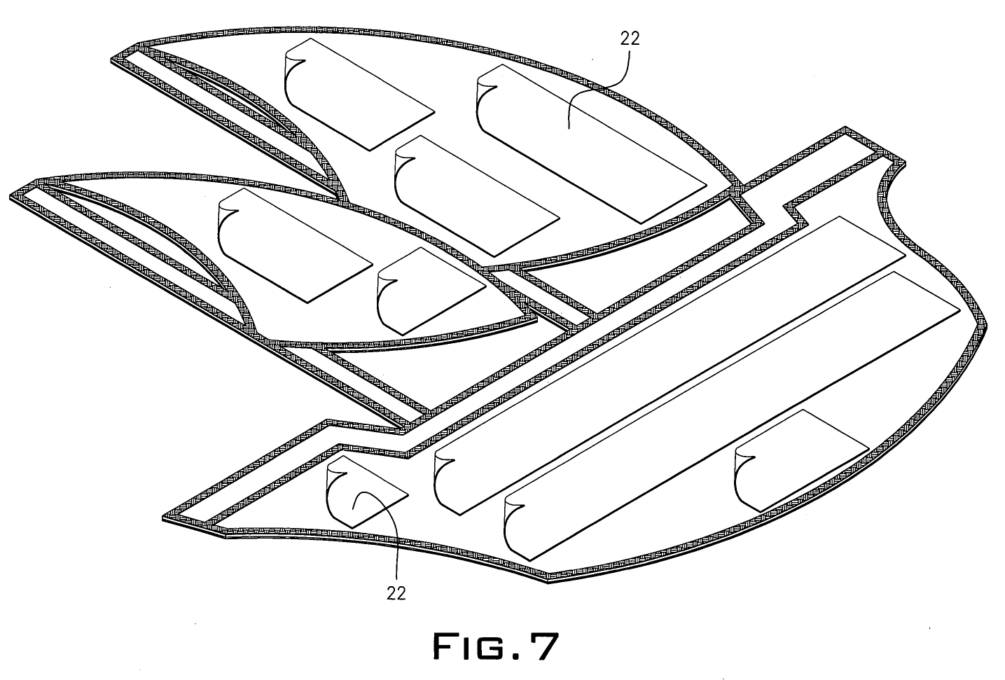

Double sided tape 22 is applied to multiple bottom surface areas 20 of the backing material 16. Thereafter, the decorative pattern 10 can be applied by sticking its back surface 20 to a wall. The decorative design pattern 10 can be easily peeled from the wall by a child and applied to another wall surface. After numerous applications and removal of the decorative design pattern, the double sided tape 22 begins to lose its tackiness. As seen in FIG. 7, the double sided tape 22 is merely peeled off and replaced and the decorative pattern is again available for placement and removal from a wall surface.

Optionally, a micro chip 24 can be applied to the top surface 26 of the decorative pattern fabric 10. A piece of fabric 28 is then stitched 30 over the microchip 24. This microchip can be a source of music or voice activation for entertainment or education as desired.

Equivalent elements can be substituted for the elements described above to provide substantially the same results in substantially the same way to achieve substantially the same function.

1. A method for preparing a removable decorative design for mounting on a wall, the method comprising:
(a) applying glue to a top surface of a polymeric crease resistant backing material;
(b) adhering a desired fabric design pattern to the backing material top surface;
(c) stitching with thread an outline of the designed design pattern onto the backing material top surface;
(d) cutting the desired design pattern away from the backing material not covered by the threaded outline of the desired design pattern; and
(e) applying double sided sticky tape to a back surface of the backing material so that the desired design can be stuck to a wall surface and easily removed therefrom.

2. The method for preparing a removable decorative design according to claim 1 wherein the double sided sticky tape is removed and replaced after multiple uses.

3. The method for preparing a removable decorative design according to claim 1 wherein a voice or music chip is mounted on a top surface of the decorative design by stitching a fabric cover over the chip.

4. The method for preparing a removable decorative design according to claim 1 wherein the polymeric crease resistant backing material is provided as polypropylene.

5. The method for preparing a removable decorative fabric design according to claim 1 wherein the design pattern is provided as a cotton fabric.
